(19) United States
(12) Patent Application Publication
(10) Pub. No.: US 2025/0153246 A1
(43) Pub. Date: May 15, 2025

(54) GAS MANAGEMENT SYSTEM FOR BINDER JETTING ADDITIVE MANUFACTURING

(71) Applicant: Desktop Metal, Inc., Burlington, MA (US)

(72) Inventors: Emanuel SACHS, Burlington, MA (US); Joseph JOHNSON, Burlington, MA (US); Kurt JOUDREY, Burlington, MA (US); Mitch NOAH, Burlington, MA (US)

(21) Appl. No.: 18/839,030

(22) PCT Filed: Feb. 15, 2023
(86) PCT No.: PCT/US2023/013096

§ 371 Date: Aug. 16, 2024

Related U.S. Application Data
(60) Provisional application No. 63/312,293, filed on Feb. 21, 2022.

(51) Int. Cl. B22F 12/70; B22F 12/00; B28B 1/00; B33Y 30/00; B33Y 40/00; C03C 27/10

(52) U.S. Cl. CPC B22F 12/70; B22F 12/38; B28B 1/001; B33Y 30/00; B33Y 40/00; C03C 27/10

(57) ABSTRACT

A gas management system for binder jetting additive manufacturing from build material powder includes a first volume at least partly within a binder jet printer that contains gas at a first pressure. A second volume encloses a plurality of process modules configured to deposit and bind build material powder. The second volume contains gas at a second pressure. A boundary between the first and second volumes includes a partition providing separation between the volumes and controls gaseous communication between them. A gas management system maintains a conditioned environment within the second volume during printing by selectively providing an inflow of process gas to the second volume. Process gas flows from the first volume to the second volume. The first pressure of the gas in the first volume is greater than the second pressure of the gas in the second volume.

### RELATED APPLICATIONS

This application is a US National Stage Application, filed under 35 U.S.C. § 371, of International Application PCT/US2023/013096, filed on Feb. 15, 2023 and claims priority to U.S. Patent Application 63/312,293, filed on Feb. 21, 2022; the contents of the above applications are incorporated by reference herein in their entirety.

### TECHNICAL FIELD

Various aspects of the present disclosure relate generally to systems and methods for facilitating binder jetting additive manufacturing.

### BACKGROUND OF THE DISCLOSURE

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed. After printing, the bound part may be, in reversible order, cured or crosslinked to strengthen the binder, and removed from the excess build material powder.

Management of conditions in the area where binder jetting is being performed can be important to safety and part quality. For example, it is important in many cases that powder representing a combustion risk is exposed to an inert environment during printing. It may also be important to manage build material powder migration through components of the printer and limit contamination of components that are functionally sensitive to powder or that may provide an ignition source for combustion (e.g. present a spark risk). It is therefore desirable to manage the gas environment in binder jetting printers.

### SUMMARY

Disclosed are systems and methods pertaining to a gas management system used during a binder jet additive manufacturing process from build material powder. A binder jet additive manufacturing process may employ a binder jet printer to fabricate objects from a build material powder and a binder. The binder jet printer may form an enclosure within which the objects are fabricated, and the gaseous atmosphere within the enclosure may be controlled to assist the additive manufacturing process. A gas management system may accomplish, or contribute to, at least a portion of the control. Further features of the binder jet printer (such as additional volumes, boundaries between two or more volumes, a partition at or near a boundary, or a gas management system, for example) may be utilized to tune and control the atmosphere in the binder jet printer as compared to atmosphere exterior to the binder jet printer, or as compared to embodiments lacking the features disclosed herein.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a component schematic diagram of a binder jetting printer for use with embodiments of the present disclosure.

FIG. 2 depicts a cutaway view of the binder jetting printer of FIG. 1.

FIG. 3. is a perspective view of a binder jetting printer according to an exemplary embodiment of the present disclosure.

FIG. 4 depicts the volumes within a binder jetting printer according to an exemplary embodiment of the present disclosure.

FIGS. 5A-C depict schematic views of a gas management system according to an exemplary embodiment of the present disclosure.

FIGS. 6A-B depict a baffle system according to an exemplary embodiment of the present disclosure.

FIG. 7 depicts a side schematic view of a baffle system within a binder jetting printer according to an exemplary embodiment of the present disclosure.

FIGS. 8A-G depict a gas management system in various modes of operation according to an exemplary embodiment of the present disclosure.

FIG. 9 is a perspective view of a gas management system according to an exemplary embodiment of the present disclosure.

FIG. 10 is a perspective view of a door assembly for a gas management system according to an exemplary embodiment of the present disclosure.

FIG. 11 depicts a cutaway view of a carriage assembly and a binder jetting unit and a binder reservoir.

FIGS. 12A-B are perspective views of a carriage assembly traversable via a motor system according to an exemplary embodiment of the present disclosure.

### DETAILED DESCRIPTION

In the process of binder jetting additive manufacturing, a build material powder is delivered to and spread upon a build surface and a binding agent (or binder or ink) is deposited on the build material powder to at least partially bind the build material powder to form a slice of a 3D object. By repeating the steps of delivering a build material powder, spreading a build material powder, and depositing a binder corresponding to a desired image, a 3D structure may be formed. This process is understood to occur in a binder jetting printer (or binder jet printer).

In certain embodiments, a binder jet printer may comprise a print enclosure with a number of modules configured to aid in or accomplish the additive manufacturing of parts and other objects from a build material powder. These modules may include: (1) an assemblage of printheads (or one printhead in certain embodiments), (2) an ink delivery system to supply the printheads with binder at flow and pressure conditions necessary for stable binder ejection from the printhead, (3) a build material supply module to deliver an amount of build material powder to a print surface within the printer, (4) a build material spreading module to spread an amount of build material powder which has been supplied to a print surface to a controlled thickness, (5) a container and motion system to contain the build material powder and during printing move the container to specific positions (e.g., by moving in a first direction relative to a least one of the modules (1)-(4)) to enable the fabrication of successive layers of an object. In some embodiments, the printer may comprise additional modules including: (6) devices configured to reduce, prevent, or remove build material powder and/or ejecta from the printhead that may become suspended in an atmosphere in the print enclosure, including, according to certain embodiments, devices which deposit liquids (e.g., water, alcohol, oils, and the like) onto a surface of the build material powder to alter the cohesive characteristics of the powder, devices which control and/or provide a flow of gas to remove and/or filter suspended ejecta, (7) devices configured to control the gaseous atmosphere within the print enclosure relative to a gaseous atmosphere surrounding the binder jet printer, and (8) at least one reciprocating mechanism to provide relative motion between the container containing build material powder and at least one of the modules (1) to (4) in a second direction different from the first direction of the container and indexing system.

Build material powders may be sensitive to certain gaseous atmospheres. According to certain embodiments, it is desirable to prevent, minimize, or otherwise avoid gaseous communication between certain gaseous species and specific metal powders. For example, a copper build material powder may oxidize when in contact with air. In certain embodiments of the binder jetting printing process, such an oxidation of copper may be deleterious to the printing process for at least the reason that the oxidation may be uncontrolled and may introduce uncertainty into certain aspects of the binder jet printing process. In certain embodiments, a build material powder may be reactive (e.g, pyrophoric or explosible) with moisture and the build material powder should be kept separate from a base level of moisture contained in ambient air (e.g., room humidity). In certain embodiments, a build material powder may not be chemically sensitive (e.g., prone to oxidation, explosibility, pyrophoricity, or other means of chemical reaction) but may exhibit a change in physical properties such as the ability of the build material powder to flow. In the case where the flow characteristics of the powder will vary, degrade, or otherwise change, maintaining a consistent atmosphere around the build material powder may be required.

In another embodiment, build material powders may be reactive (e.g. pyrophoric or explosible) in the presence of oxygen and ignition sources capable of providing energy above the minimum ignition energy or temperatures above the minimum ignition temperature of the powder. Certain of the process modules (1) to (8) may provide sufficient energy or temperature to exceed these ignition limits, creating a condition in which a reaction may occur. In such cases, it may be desirable to maintain the printing environment in an inerted state, with the oxygen concentration of the atmosphere maintained below a predetermined concentration which is lower than the limiting oxygen concentration, or the concentration below which combustion of the build material powder does not readily occur. A typical target oxygen concentration may be 2%, which is below a typical limiting oxygen concentration of 4-15% for commonly printed materials.

In the process of binder jet additive manufacturing, a build material powder is typically supplied to a binder jet printer and some amount of this build material powder is bound using a binder to form objects. These objects are provided with various names in the field of art, and may be referred to as green parts, but are sometimes also referred to as brown parts. In certain embodiments, the objects formed may include parts that, as one skilled in the art will appreciate, may undergo subsequent post-processing steps (perhaps including a curing, drying, or crosslinking step) to improve the mechanical properties (such as strength, fracture toughness, elongation to failure, and the like) of the bound object.

### Post-Processing

In certain embodiments, post-processing (such as curing, drying, crosslinking, and the like) may be optionally performed to improve the mechanical properties of objects fabricated from build material powder and binder. In certain embodiments, the improvement of mechanical properties attained during the post-processing steps may reduce breakages of objects that can occur during the removal of unbound build material powder from the surfaces of the objects formed from binder and build material powder. This process of removing unbound build material powder (that is, powder which is not held or adhered to an object with binder) is often termed “depowdering”. As one skilled in the art may appreciate, several approaches may be pursued to depowder parts.

### Objects: Parts and Supports

Several types of objects may be printed using a binder jet printer. In certain embodiments, a single object may comprise a single part. In certain embodiments, a single object may comprise a series of parts connected with a mechanical linkage permitting relative motion (such as a hinge, slide, or other element). In certain embodiments, a single object may comprise a series of parts connected with a mechanical linkage in which motion is prohibited, substantially prohibited, or the parts are otherwise fully constrained in all directions of translation and rotation. In certain embodiments, a single object may comprise a series of parts connected with at least one mechanical linkage permitting motion in at least one direction, and prohibiting motion in at least one other direction (such as, for example, in a sliding mechanism permitting motion in a first sliding direction with constraint imposed in a second constraining direction orthogonal to the first direction). In certain embodiments, a single object may comprise a part and a supporting structure, where the supporting structure may be configured to touch, abut, hold, cradle, or otherwise contact the part at or through at least one point across opposed surfaces of the part and support structure. In certain embodiments, the support structure may provide a means of support to the part. In certain embodiments, the means of support may be mechanical, such that the support structure, through the at least one point, carries a stress or force transmitted through or imposed upon the part. In certain embodiments, the part and the support may be printed in a first configuration and brought to contact in a second configuration, where the second configuration enables the support structure to provide support to the part.

### Thermal Processing

Following binder jet printing and optional post-processing of the object, the object may be further subjected to thermal processing, according to certain embodiments. The thermal processing may include the steps of debinding and sintering of the object.

### Debinding

During debinding, binder is removed from the object. Debinding may be performed in any suitable chamber or enclosure. In certain embodiments, a suitable chamber or enclosure may include a means of heating the object, a means of providing a flow of process gas, a means of evacuating a process gas, and a means of controlling a pressure of the process gas, as will be appreciated by one skilled in the art.

Not being bound by theory, debinding may remove binder by a thermally activated process of evaporation, sublimation, combustion, oxidation, or degradation, according to certain embodiments. Depending upon the specific binder and build material powder materials in the object undergoing debinding, the debinding process may be tailored to achieve the desired amount of debinding.

In certain embodiments, the debinding process may begin at any temperature from the list of starting debinding temperatures: 200, 250, 300, 350, 400, or 450 degrees centigrade. In certain embodiments, the debinding process may end at any temperature from the list of ending debinding temperatures: 250, 300, 350, 400, 500, or 600 degrees centigrade. For example, a debind process may occur between 200 and 350 degrees centigrade, or may occur between 300 and 600 degrees centigrade. It should be understood by one skilled in the art that the starting debinding temperature will be less than the ending debinding temperature.

The debinding process may require the maintenance of a specific gaseous atmosphere surrounding the objects, according to certain embodiments. The gaseous atmosphere may include the gases argon, nitrogen, oxygen, hydrogen, helium, carbon dioxide, carbon monoxide, ammonia, methane, air, or the like. According to certain embodiments, the gaseous atmosphere may be a mixture of gases. According to certain embodiments, the gaseous atmosphere may be substantially absent and a vacuum may exist about the parts. According to certain embodiments, a gaseous atmosphere may be provided by a process gas.

The debinding process may require, or more optimally perform with a specific pressure or range of pressures of a process gas. According to certain embodiments, the pressure of the gaseous atmosphere during debinding may be equal to or may exceed 1 atmosphere. According to certain embodiments, the pressure of the gaseous atmosphere during debinding may be between 0.5 and 1 atmosphere. According to certain embodiments, the pressure of the gaseous atmosphere may be between 0.01 and 0.5 atmospheres. According to certain embodiments, the pressure of the gaseous atmosphere may be between 0.01 and 10 Torr. According to certain embodiments, the pressure of the gaseous atmosphere may be less than 0.01 Torr. In certain embodiments, a desired pressure may be maintained with a vacuum pump and a supply of process gas, where the volume of gas removed by the pump and the supply of process gas at least partially determine the pressure within the debind chamber.

### Sintering

Following the removal of at least a portion of the binder by the debinding process, the object may then be sintered, according to certain embodiments. In certain embodiments, the objects may be sintered without the removal of the binder, or without the binder removal step.

Not being bound by theory, during the process of sintering, the build material powder is heated to result in the joining of the build material powders to form a sintered object. The sintered object may exhibit a density larger than the density of the object prior to sintering, according to some embodiments. The object may be sintered without the melting of any build material powder, according to certain embodiments. The object may be sintered with the melting of only a portion of the build material powder, according to certain embodiments.

The process of sintering typically occurs in a sintering furnace, as will be appreciated by one skilled in the art. According to some embodiments, the sintering furnace may include a means of heating the object to be sintered. According to some embodiments, the sintering furnace may include a means of providing a flow of sintering process gas to the objects to be sintered, in such a way that the gaseous atmosphere around the objects to be sintered is at least partially controlled. According to some embodiments, the sintering furnace may include a means of controlling the pressure of a gaseous atmosphere around the objects during the sintering process (the “sintering pressure”). According to some embodiments, the means of controlling the pressure of a gaseous atmosphere around the objects during sintering may include a vacuum pump and at least one conduit to enable gaseous communication between a chamber housing the object to be sintered and the vacuum pump.

The gaseous atmosphere surrounding the object during sintering is often an important aspect of the sintering process. According to certain embodiments, the gaseous atmosphere may be comprised of hydrogen, helium, argon, nitrogen, carbon dioxide, carbon monoxide, methane, forming gas (a mixture of hydrogen and argon), ammonia, or air. According to certain embodiments, the gaseous atmosphere may be comprised of a mixture of gasses (95% nitrogen and 5% hydrogen by weight, for example). Careful selection of the gaseous atmosphere may promote certain mechanisms of sintering and lead to a desired amount of densification. As will be understood by one skilled in the art, the composition of the gaseous atmosphere surrounding the object during sintering may change during the sintering process, for example according to a predetermined schedule and in a coordinated fashion with the temperature, pressure, and flow rates as a function of time.

The pressure of the gaseous atmosphere surrounding the object during sintering is often an important aspect of the sintering process. According to certain embodiments, it is desirable to decrease the pressure in the sintering furnace to enhance the densification (that is, to increase the density) of an object undergoing sintering. According to certain embodiments, it is desirable to increase the pressure in the sintering furnace to enhance the densification (that is, to increase the density) of an object undergoing sintering. The selection of pressure is typically determined by the elements from which the build material powder is comprised in addition to the interaction of the elements with the gaseous atmosphere. In certain embodiments, the pressure of the gaseous atmosphere surrounding the object during sintering is at least 1 atmosphere and up to 5 atmospheres. In certain embodiments, the pressure of the gaseous atmosphere surrounding the object during sintering is at least 0.5 atmosphere and less than 1 atmosphere. In certain embodiments, the pressure of the gaseous atmosphere surrounding the object during sintering is at least 0.1 atmosphere and less than 0.5 atmosphere. In certain embodiments, the pressure of the gaseous atmosphere surrounding the object during sintering is at least 0.001 Torr atmosphere and less than 10 Torr. In certain embodiments, the pressure of the gaseous atmosphere surrounding the object during sintering is less than 0.001 Torr. As will be understood by one skilled in the art, the pressure of the gaseous atmosphere surrounding the object during sintering may change during the sintering process, for example according to a predetermined schedule and in a coordinated fashion with the temperature, composition, and flow rates as a function of time.

In some embodiments, the steps of debinding and sintering may occur during a sequentially in the same chamber, as part of a processing operation. For example, a single furnace may be used to first debind a part by controlling its temperature through starting and ending debind temperatures, and continuing to sintering temperatures without first cooling the part from the ending debind temperature.

### Build Material Powders

In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6A1-4V titanium, F75 Co—Cr—Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yttria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a binder jet printer may include a container to contain the build material powder and printed structures. The container may be indexable moveable relative to the build material delivery and spreading mechanisms, and may also be indexable relative to an inkjet head or heads which deposit the binding agent in a desired pattern to form a slice of a 3D structure on the surface of a powder bed. As may be appreciated by one skilled in the art, the ability of the binder jet printer to accurately position and index the bed is crucial to the performance of the binder jet printer, and, specifically, is crucial to the layer-to-layer tolerance of the objects (or parts) produced by the binder jet printer.

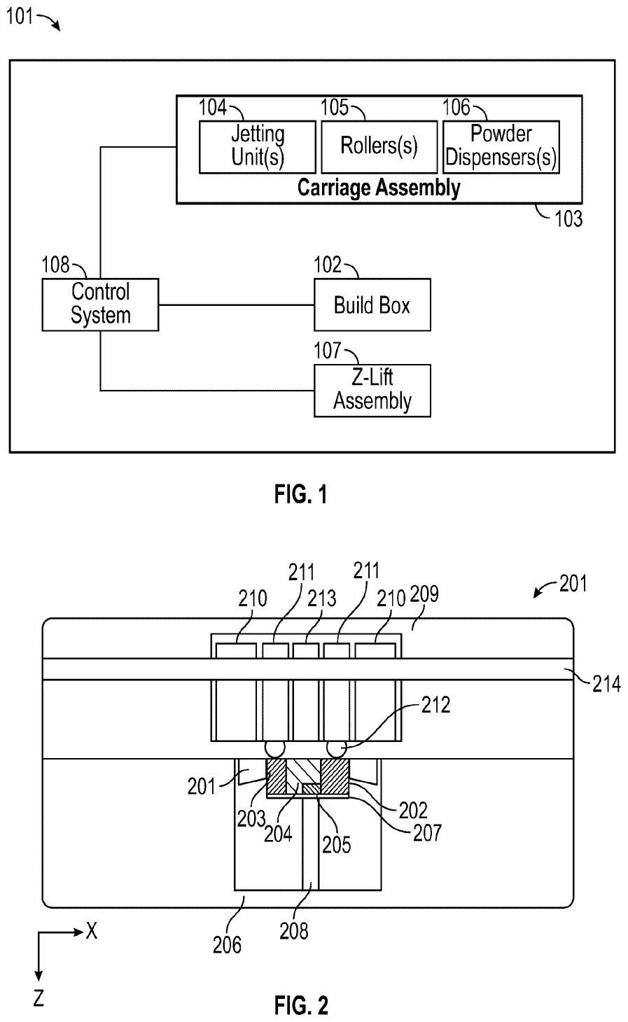

With reference to FIG. 1, a binder jetting printer 101 includes a build box 102 where a part is to be manufactured. A carriage assembly 103 is moved relative to the build box 102 to deposit successive layers of build material powder and binder to form parts. In certain embodiments, the binder jetting printer 101 can be used to manufacture metal parts. In these instances, the build material powder is metal powder, and the part is later thermally processed, which may include sintering, to densify the part. The carriage assembly includes jetting unit(s) 104 for depositing binder, roller(s) 105 for spreading powder layers prior to binder jetting and optionally powder dispenser(s) 106 which meter build material powder for successively printed layers. In alternate embodiments, build material powder may be metered from a feed piston in the plane of the build box and spread across the build box. In the embodiment of FIG. 1, the printer 101 includes a lift assembly 107 which moves a build platen within the build box down as successive layers are printed. A control system 108 controls the various elements of the binder jetting printer 101.

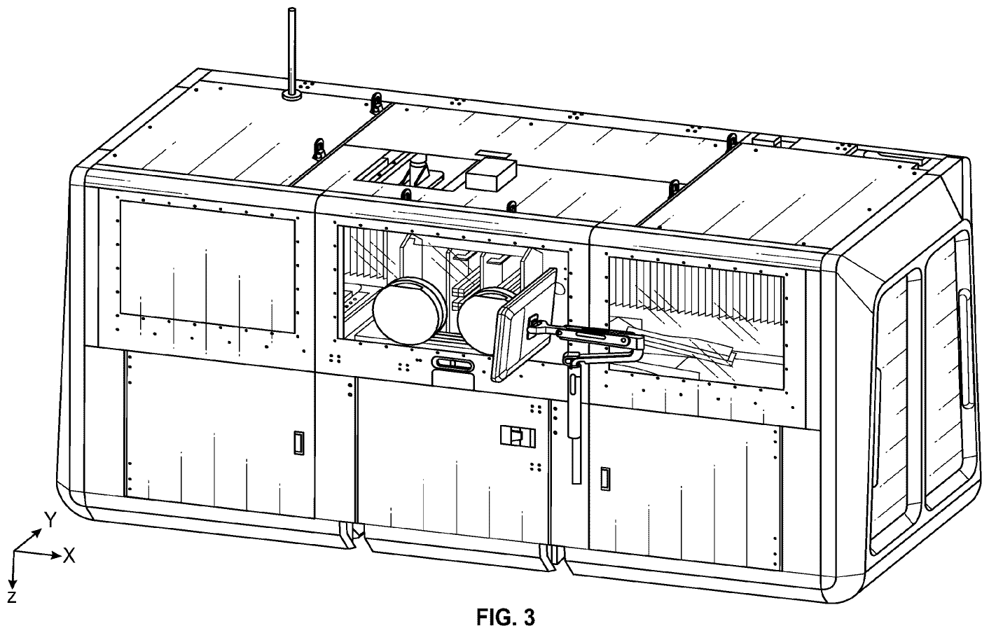

FIG. 2 depicts a side cutaway view of a binder jetting printer 201. A build box 202 contains loose powder 203 and a part 204 being manufactured and potentially support structures 205. A lift assembly 206 is configured to raise and lower the build box and build platen 207 along a direction aligned with the z coordinate axis to facilitate the printing process. A lift 208 raises and lowers a build platen 207. A print carriage 209 traverses relative to the build box. In the depicted embodiment, the print carriage moves along a direction aligned with the x coordinate axis. In the depicted embodiment, the carriage 209 moves while the build box 202 is maintained in a static position, though the build box 202 could alternatively move while the carriage 209 is maintained in a static position. In the depicted embodiment, the carriage 209 includes an arrangement of components (sometimes referred to as modules) for use in jetting. In the embodiment, printing is bi-directional, i.e., in a first direction—left to right (from −x to +x) with reference to the figure, and then from right to left (from +x to −x). To facilitate bi-directional printing, the depicted carriage 209 includes powder dispensing units 210, powder roller units 211 having rollers 212 and a jetting unit 213. The powder dispensing units 210 and powder roller units 211 alternate depending on the printing direction so that powder is dispensed ahead of the roller which distributes the powder before the single jetting unit 213 deposits binder. Rail system 214 facilitates the movement of print carriage 209.

FIG. 3 is a perspective view of an embodiment binder jetting printer.

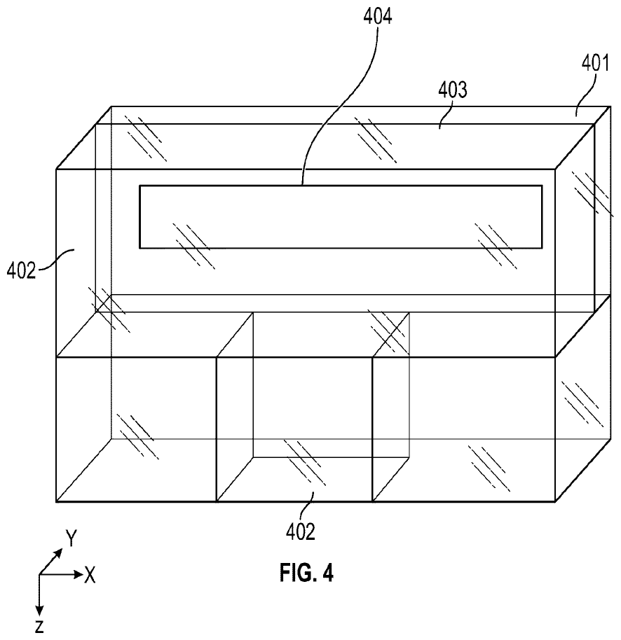

FIG. 4 depicts the outlines of gaseous volumes definable in an embodiment binder jetting printer. There is a first volume 401 and a second volume 402, which are separated by a partition 403 controlling gaseous communication between the first volume and second volume. In the embodiment the partition includes an aperture 404 between the first volume 401 and the second volume 402. In the embodiment, the second volume 402 includes or in certain embodiment is commensurate with a printing area. The printing area during binder jetting printing may be contaminated with excess powder, which inevitably leaves the build plate and migrates through the printing area as it becomes airborne. Simultaneously, for powders requiring a conditioned gaseous environment, it is desirable to maintain an inert environment.

In certain embodiments, the binder jet printer may include a volume, the volume may be fully contained within the printer enclosure. For example, in certain embodiments the volume may include spaces within the printer where build material powder transits between a metering apparatus to supply the build material powder and a receiving area such as the upper surface of a powder bed or build box of build material powder. The volume may be a first volume or a second volume.

In certain embodiments, a volume may reside partly within the printer enclosure, or any other suitable boundary of the printer. For example, in certain embodiments, the volume may reside partly within the area surrounding the printer (such as laboratory, shop, or any other space suitable for housing a binder jet printer), and may partly reside within the printer enclosure (such that at least a portion of the volume is interior to the printer) and gaseous communication may exist between the portion of the volume exterior to the printer and the portion of the volume interior to the printer. The volume may be a first volume or a second volume.

In certain embodiments, the binder jet printer may entirely enclose a first volume and a second volume.

In certain embodiments, the first volume and second volume may mate at a boundary, or other suitable interface. In certain embodiments, a partition may provide some degree of separation between, or at least demarcate, the first volume and the second volume.

It may be desirable, in certain embodiments, to utilize a flow of gas directed from a first volume to a second volume, via the boundary. In certain embodiments, this flow may occur through or around a partition or other barrier. The flow of gas may provide a degree of sealing between the first and second volume—during the process of binder jet additive manufacturing from build material powder, build material powder may become suspended in the gaseous atmosphere within the printer and transit, via motions of the gaseous atmosphere and/or the momentum of the build material powder itself, to various surfaces, modules, or other objects, areas, and spaces within the printer. The transit and subsequent deposition of build material powder to specific areas and on specific objects within the binder jetting printer (for example sensitive electronics, sensors, circuit boards, inkjet print heads, or any other apparatus within the binder jetting printer) may be deleterious to the operation of at least the specific objects. As such, it may be desirable, in certain embodiments, to direct or otherwise control the transit and deposition of build material powder to avoid, or at least minimize or mitigate, such deleterious effects. The flow of a gas through the boundary (which may include a partition, in certain embodiments) may be tuned or otherwise selected to reduce (or bring to an acceptable amount) the migration of a build material powder across the boundary between a first and a second volume. In certain embodiments, the first volume may serve as a source of a gas and the second volume may serve as a sink of the gas, such that the gas flows from the first volume to the second volume and the gas provides at least some amount of sealing resulting in a decrease of build material powder migration from the second volume to the first volume. In certain embodiments, the gas may be a process gas. In certain embodiments, the process gas may include at least some amount of gas recycled from a source including the printer. In certain embodiments, a gas management system may control the flow of process gas.

In certain embodiments, a flow of process gas may result from a pressure control scheme where a first volume is held at a first pressure and a second volume is held at a second pressure, and where the second pressure is less than the first pressure. In certain embodiments, the pressures may be controlled by a gas management system.

In certain embodiments, it may be desirable to control the gaseous atmosphere for at least the purpose of maintaining a specific gas atmosphere within volumes interior to the print enclosure. For example, in certain embodiments, the maintenance of a specific gas atmosphere may accomplish the exclusion of a specific gas or gases from a volume interior to the print enclosure. In further embodiments, the maintenance of a specific gas atmosphere within a volume interior to the print enclosure may provide an advantage to, or enable, a process of binder jet additive manufacturing using a build material powder.

In some embodiments, the pressures maintained in a first volume or a second volume, or both a first and second volume, may be greater than a pressure of the surrounding ambient environment (i.e. greater than atmospheric pressure). A typical pressure of the second volume may be between 0.5 mbar and 25 mbar greater than the surrounding ambient environment.

As described previously, a build material powder may comprise a metal or a ceramic in powdered (or finely divided) form. In certain embodiments, a build material may be explosible, pyrophoric, or otherwise exhibit a sensitivity toward specific gases. In certain embodiments, a sensitivity may include oxidation of the build material powder. By way of non-limiting example, processing a build material powder comprised of aluminum may require that a volume interior to the print enclosure be largely, substantially, or nearly completely devoid of oxygen, or of air, or of water vapor, or of a plurality of air, oxygen, or water vapor, as those gases may damage the build material powder. Further, in addition to possibly damaging the build material powder, the presence of oxidizing species such as oxygen, air, or water may enable severe reactions between the gaseous species and the aluminum build material powder resulting in an explosion or other undesirable event (such as a fire, deflagration, or the like).

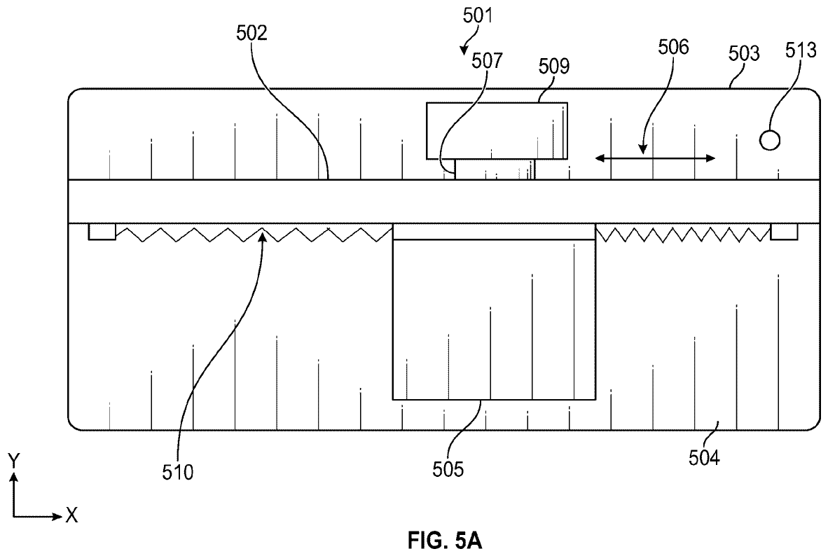

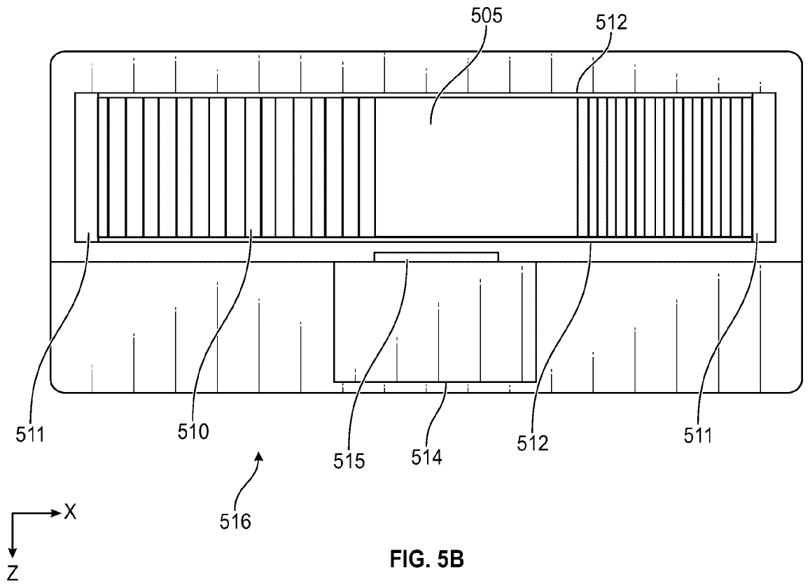

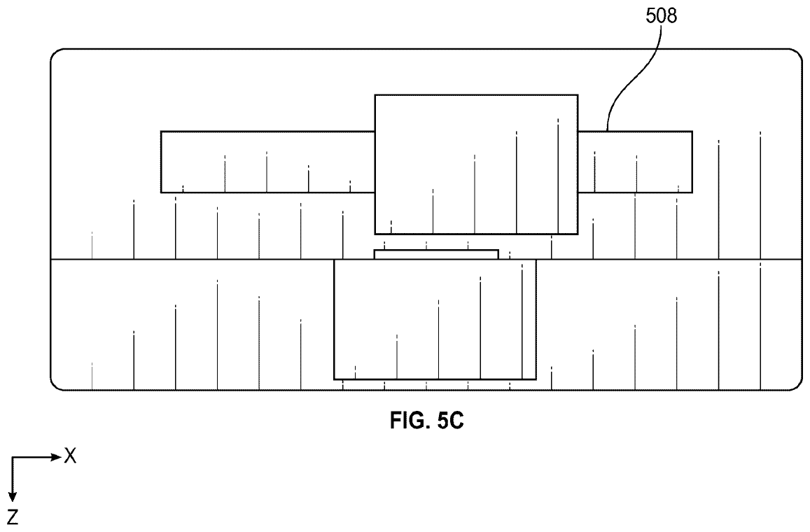

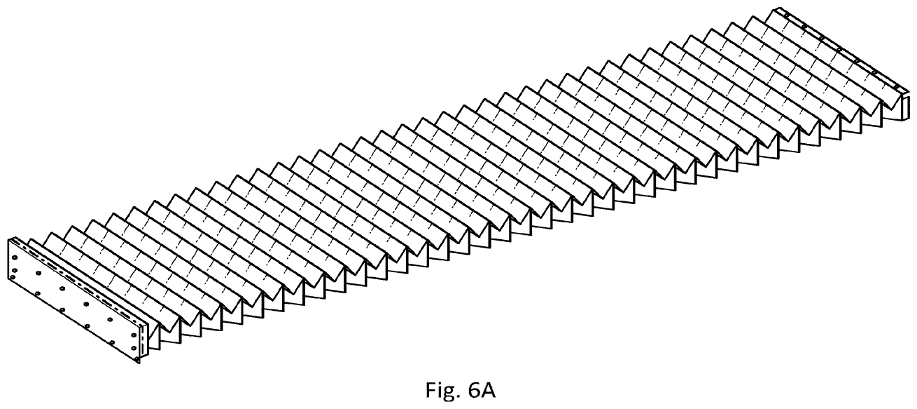

FIG. 5A depicts a top cutaway view of an embodiment binder jetting printer 501. A partition 502 separates a first volume 503 and a second volume 504. A print carriage 505 is configured to print binder in a first and optionally second direction along axis 506. In certain embodiments, the first direction may be the x-direction and a second direction along an axis may be the negative x-direction. It should be appreciated that the print carriage and printhead may be configured such that while printing binder along a first direction, the printed image may span a direction perpendicular to the direction of motion of the print carriage. In some embodiments the printed image may extend along the y-direction while the print carriage motion is in the x-direction. A carriage arm 507 extends through an aperture 508 (visible in FIG. 5C) onto which the print carriage 505 is mounted. A mechanical articulation unit (not pictured) is configured to traverse the carriage arm 507 and thus the print carriage 505. The mechanical articulation unit may be disposed such that it is housed primarily or completely within the first volume. In some embodiments, the mechanical articulation unit may comprise a timing belt connected to the carriage and coupled with a motor configured to move the print carriage along an axis. In other embodiments, the mechanical articulation unit may comprise a linear motor, or any other suitable mechanism for causing controlled motion of the print carriage along an axis. Other electronics sensitive to dust (or build material powder) contamination may also be housed in the first volume 503. A baffle system 510 at least partially gaseously isolates the first volume 503 from the second volume 504. In certain embodiments, a baffle may be a partition.

FIG. 5B depicts a front plan view of the interior of the binder jetting printer 501. The baffle system 510 is sealed at one end to brackets 511 and at another end to print carriage 505. The baffle system 510 rides along a track system 512 and contracts and expands to restrict gaseous communication through the aperture 508 (See FIG. 5C). While the baffle system does not completely isolate the second volume 504 from the first volume 503 it greatly limits the gaseous communication between them. A process gas input 513 provides a process gas flow to the first volume 503. By using the process gas flow to maintain a higher gas pressure in the first volume 503 than the second volume 504 a flow of process gas from the first volume 503 to the second volume 504 will flow through the small openings between the baffle system 510 and the partition 502. The second volume 504 may be maintained at a lower, or in at least one example, higher pressure than an ambient environment 516 which may surround the binder jetting printer 501.

With reference now to FIG. 5C, a Z-lift enclosure 514 is a third volume and is configured to traverse a build box and present a build plate to the binder jetting printer 501 during printing. When a sealing plate 515 is placed to seal an aperture of the Z-lift enclosure the third volume of the Z-lift enclosure may be gaseously isolated from the remainder of the binder jetting printer 501. FIG. 5C depicts the printer 501 with the removal of baffle system 510 such that aperture 508 is visible.

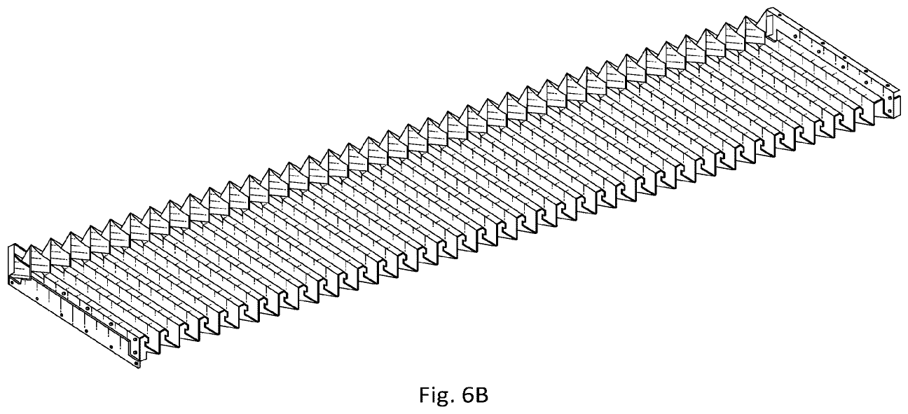

FIGS. 6A-B respectively depict a first and second perspective view of an embodiment baffle system. In certain embodiments, the baffle system prevents gaseous communication through the solid portions of the baffle, but may permit gaseous communication around the solid portions. In certain embodiments, the gaseous communication around the solid portion may provide a sufficient flow of process gas to retard or prevent the migration of build material powder against the flow of process gas.

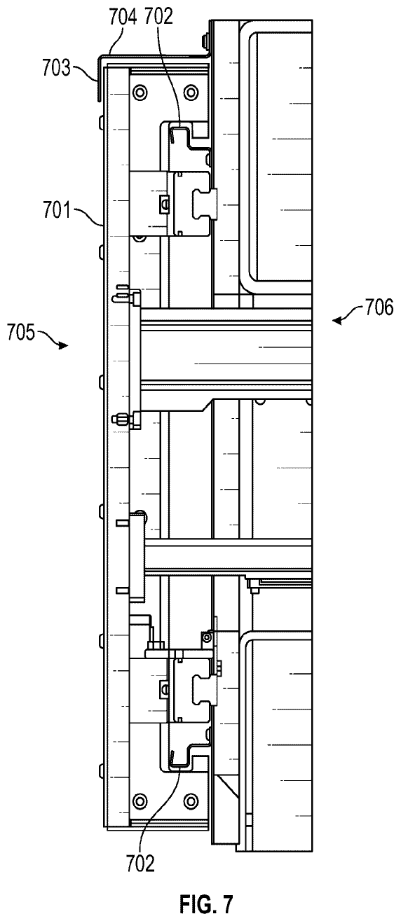

FIG. 7 depicts a side plan view of a bellows system 701. The bellows system 701 rides in rails 702. A shroud 703 provides a tortuous gas pathway 704 between a second volume 705 where printing is conducted and a first volume 706.

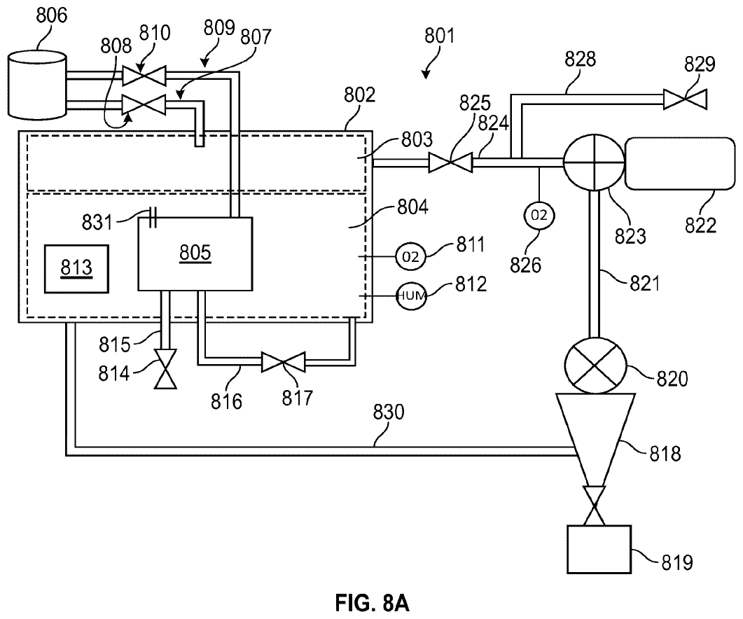

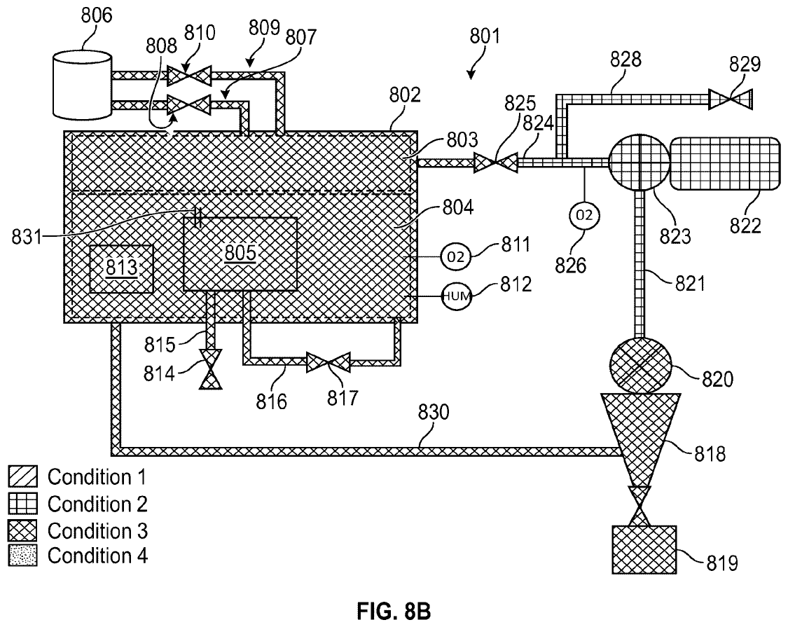

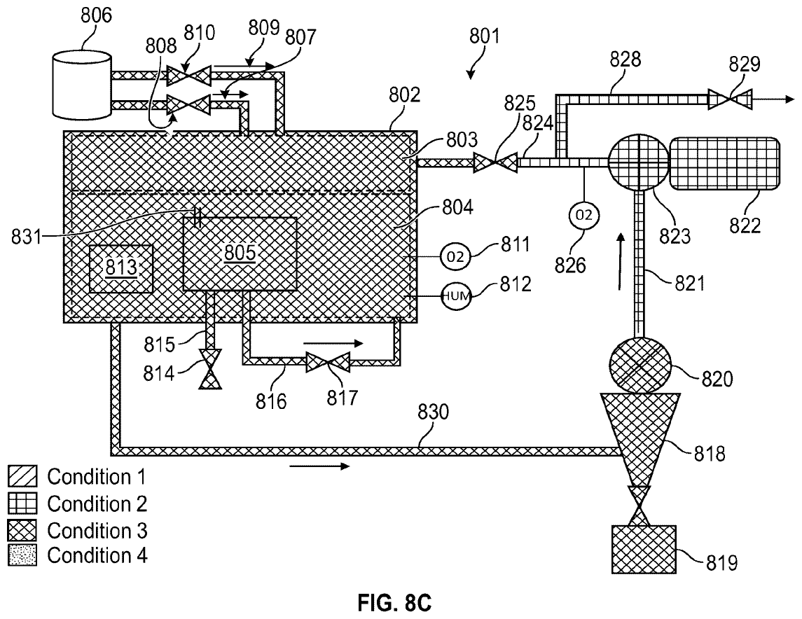

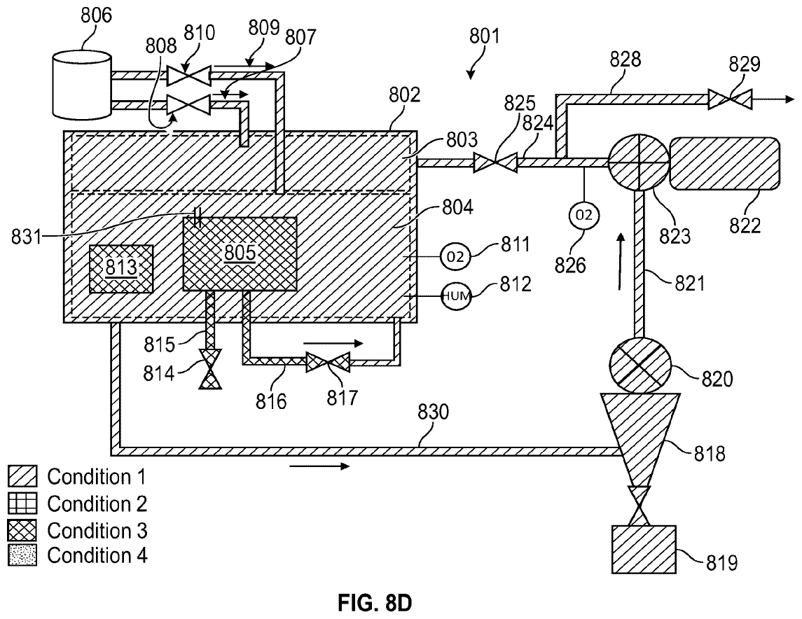

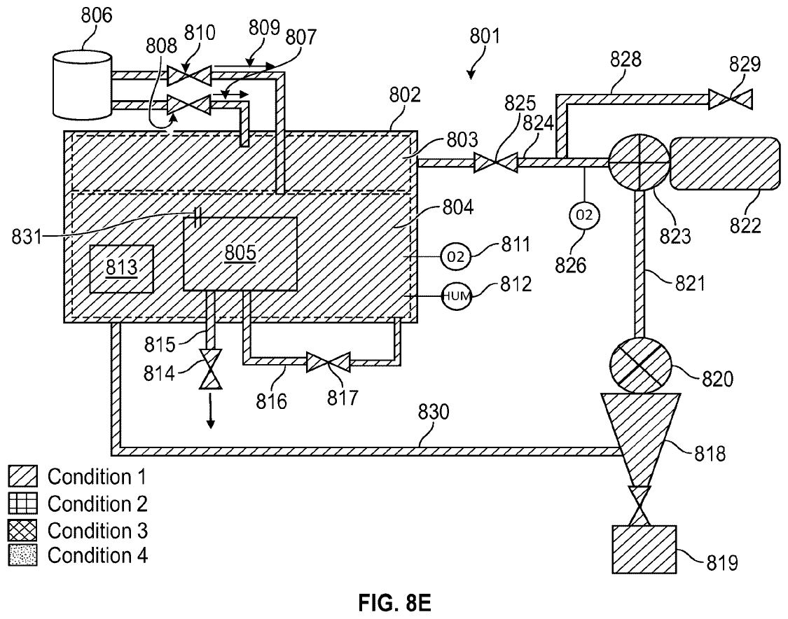

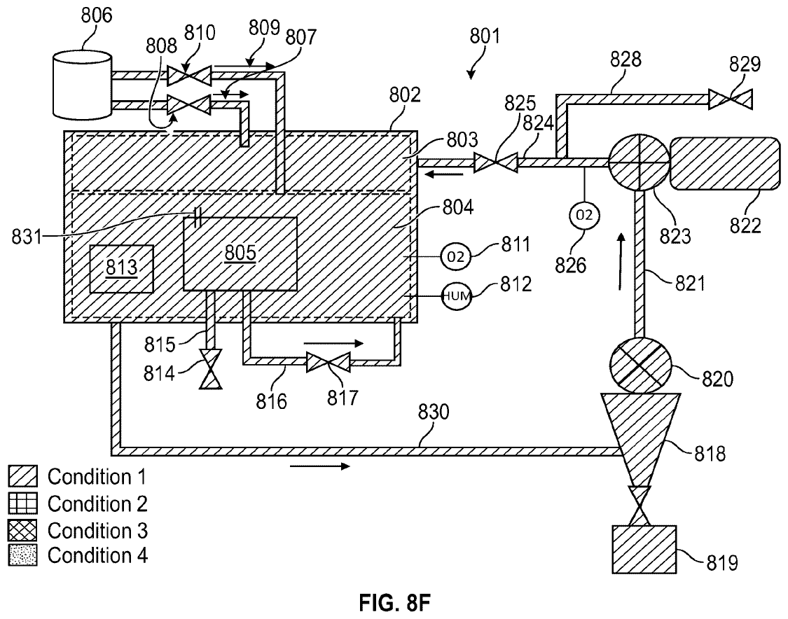

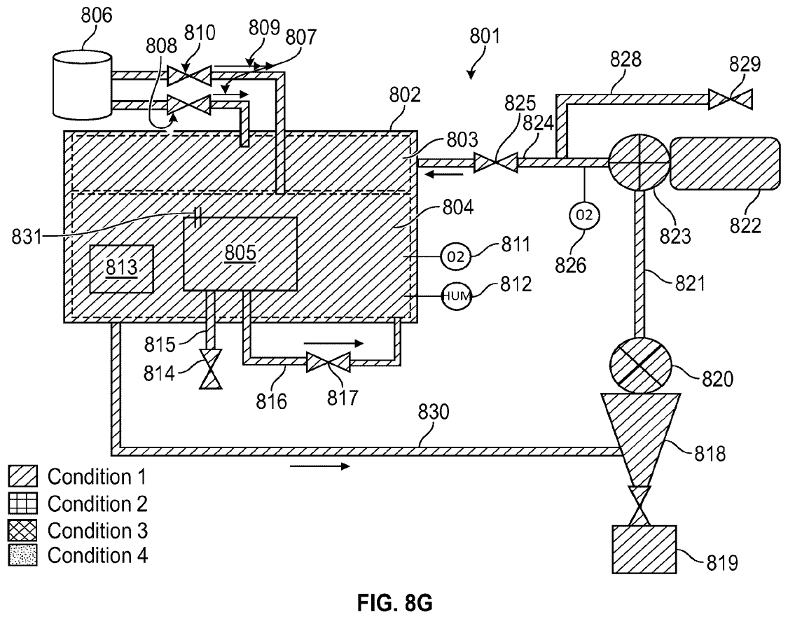

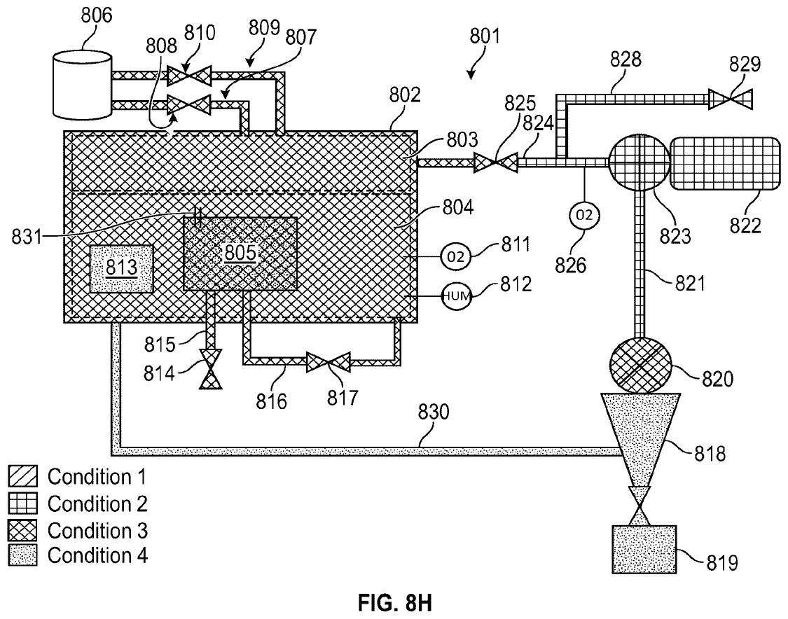

FIG. 8A depicts a gas management system 801 for binder jetting printing. A binder jetting printer 802 includes a first volume 803 and a second volume 804. A third volume is a Z-lift enclosure 805. A process gas source 806 provides process gas flow through a first conveyance loop 807 through a first valve 808 to the first volume 803. The process gas source 806 provides process gas flow through a second conveyance loop 809 to the Z-lift enclosure 805 through a second valve 810. During operation the process gas flows from the first volume 803 to the second volume 804. A first oxygen sensor 811 and a humidity sensor 812 monitor oxygen levels and humidity, respectively, in the second volume 804. An overflow collection chute 813 is employed to collect excess powder from the printing process. Excess powder may be any amount of powder which is deposited onto the print bed but which exceeds the amount of powder that a print bed can hold during the spreading of the new layer. A gas outlet valve 814 is configured to convey used process gas from the Z-lift enclosure 805 through a third conveyance path 815. The gas outlet valve 814 and third conveyance path 815 may be used during a purging operation (for example, during a startup of a printer when the oxygen concentration of the process gas is above a desired amount of oxygen, and thus return of the gas into the second volume 803 is not desirable). A fourth conveyance loop 816 is configured to recirculate process gas through a fourth valve 817 and return it to the second volume 804. A fifth conveyance loop 830 is configured to convey used process gas and powder collected in the overflow collection chute 813 from the second volume 804 to a separator 818. A powder collection unit 819 receives powder separated from the process gas filtered through separator 818. Separator 818 may comprise a filter separator, a cyclonic separator, or any type of separator suitable for separating an amount of powder suspended in a gas stream from the gas. A valve 820 controls flow of filtered process gas through a sixth conveyance loop 821 to a blower 822 that facilitates flow of gas through the gas management system via a fifth valve 823. Filtered process gas may be reflowed to the binder jetting printer 802 via a seventh conveyance loop 824 through a sixth valve 825. In other embodiments, some fraction of the process gas returned via conveyance loop 824 may be returned to the second volume 804. In some embodiments, the returned gas may be supplied to the first volume or the second volume by means of a diffuser, such that the flow of the gas does not cause undue disturbance to the binder jet printing process, such as disturbing the trajectory of the binder droplets ejected from the printheads, or disturb the build material powder during metering, spreading, or in the deposited layer in the build box. Oxygen content in the filtered process gas in the seventh conveyance loop 824 may be monitored by a second oxygen sensor 826. Process gas may also be flowed through an eighth conveyance path 828 to a facility exhaust through seventh valve 829. The seventh valve 829 and eighth conveyance path 828 may be used during a purging operation (for example, during a startup of a printer when the oxygen concentration of the process gas is above a desired amount of oxygen, and thus return of the gas into the second volume 803 is not desirable).

Certain powders may represent a combustion risk that can be categorized into four conditions. In a first condition no cloud of combustible dust is likely to occur. In a second condition, an explosive atmosphere in the form of a cloud of combustible dust is unlikely to occur and if so, exists for short periods. In a third condition, occasional explosive atmosphere in the form of a cloud of combustible dust may exist. In a fourth condition, continuous clouds of dust inside an enclosure create an explosive atmosphere for long periods or frequently for short periods. In some cases the second, third, and fourth conditions may relate to classification zones 22, 21, and 20 according to ATEX ratings for combustible dust, respectively. In certain embodiments, it may be desirable to mitigate a combustion risk arising from a choice of build material powder by controlling the gaseous atmosphere at various positions and places within a binder jetting printer, at different times. In certain embodiments, it may also be desirable to mitigate a combustion risk arising from a choice of build material powder by controlling the presence of ignition sources at various positions and places within a binder jetting printer, at different times. In some embodiments, sequences may be designed and implemented to deactivate potential energy sources for combustion during an inerting process (that is, while the oxygen concentration is being decreased) before and until the oxygen concentration is below a certain pre-determined threshold (e.g. below a limiting oxygen concentration for explosibility of the build material powder). After an acceptably low level of oxygen is achieved (that is, inerted), the energy sources may be activated.

FIGS. 8B to 8H depict the conditions of different regions of the gas management system during different states inactivity, of preparation for printing activity, printing activity, and emergency stop conditions. FIG. 8B depicts conditions and gas flows which may be commanded by the gas management system 801 in an inactive state. In some embodiments, when the gas management system is in an inactive state, the first volume, second volume, z-lift enclosure, separator, and conveyance loops and paths between these components may be considered to be in a third condition of combustion risk. In some embodiments, the sixth conveyance loop and blower may be considered to be in a second condition, since they may be isolated or separated from build material powder by means of the separator. In some embodiments, while the gas management system is in an inactive state, no gas flow may be induced; furthermore devices and elements of the printer and gas management system which may provide an ignition source for the powder may be inactive (that is, not supplied with power). In some embodiments, devices and elements which are powered down in an inactive state may include such components as electronics, circuit boards, printheads, heaters, valves, blowers, lights, or other components which are deemed capable of providing ignition energy to a build material powder while in a third condition and while the component is in a volume where the oxygen level exceeds a minimum threshold (that is, not inerted as above).

FIG. 8C depicts the conditions and gas flow experienced by the gas management system 801 during a start-up inerting step (that is, while the oxygen concentration in the gaseous environment is being reduced by means of introduction of an inert gas from a first level that may be above a desired maximum concentration, to a second level which may be below a desired concentration). In some embodiments, when the gas management system is in a start-up inerting step, the first volume, second volume, z-lift enclosure, separator, and conveyance loops and paths between these components may be considered to be in a third condition of combustion risk. In some embodiments, the sixth conveyance loop and blower may be considered to be in a second condition, since they may be isolated or separated from build material powder by means of the separator. In some embodiments, while the gas management system is in a start-up inerting state, gas flow may be induced by means of supplying gas only from the process gas source 806 without the use of blower 822. In some embodiments, during a start-up inerting step, process gas introduced into the system may be primarily or exclusively exhausted from the system via exhaust valve 289, without recirculation of gas into a first or second volume. In some embodiments, devices and elements of the printer and gas management system which may provide an ignition source for the powder may be inactive (that is, not supplied with power) during a start-up inerting step. In some embodiments, devices and elements which are powered down in a start-up inerting step may include such components as electronics, circuit boards, printheads, heaters, valves, blowers, lights, or other components which are deemed capable of providing ignition energy to a build material powder while in a third condition and while the component is in a volume where the oxygen level exceeds a minimum threshold (that is, not inerted as above).

FIG. 8D depicts the conditions and gas flow experienced by the gas management system 801 during an inerted state.

FIG. 8E depicts the conditions and gas flow experienced by the gas management system 801 during the installation of a build box.

FIG. 8F depicts the conditions and gas flow experienced by the gas management system 801 during normal operation in which the system is inerted. In some embodiments, when the system is inerted, all components of the system may be considered to be in a first condition. In some embodiments, devices and elements of the printer and gas management system which may provide an ignition source for the powder may be activated (that is, supplied with power) while in an inerted state. In some embodiments, the inerted state may be the normal state for binder jet additive manufacturing.

FIG. 8G depicts the conditions and gas flow experienced by the gas management system 801 during a normal shutdown. In some embodiments, when the system is placed in a normal shutdown state, a reduced flow rate of inert gas may be maintained from the process gas source into the first volume or the second volume or the z-lift enclosure. In some embodiments, the valves may be configured to recirculate the process gas through one or more of the conveyance loops while in a normal shutdown state, to maintain an inerted state of the first volume, second volume, z-lift enclosure, and conveyance loops. Maintaining the system in an inerted state while in a normal shutdown state may be desirable as it may allow future startup and printing operations to occur in a shorter time or with less use of process gas, compared to the condition where the printer is allowed to lose its inert status. In some embodiments, when the system is in a normal shutdown state, all components of the system may be considered to be in a first condition.

FIG. 8H depicts the conditions and gas flow experienced by the gas management system 801 during an emergency shutdown. An emergency shutdown may occur in some cases due to unexpected circumstances, such as loss of power, or loss of process gas supply, or the like. In some embodiments, when the system is in a state of emergency shutdown, a first volume, second volume, and z-lift enclosure may be considered to be in a third condition. In some embodiments, an overflow collection chute 813, fifth conveyance loop 830, and separator 818 may be considered to be in a fourth condition. In some embodiments, the sixth conveyance loop and blower may be considered to be in a second condition, since they may be isolated or separated from build material powder by means of the separator. In some embodiments, an emergency shutdown state, process gas supply may be disabled. The gas management system 801 may further have a pressure equalization tube 831 between the second volume 804 and the Z-lift enclosure 805 configured to equalize pressure differences between the two areas occurring while moving a build platen which otherwise may result in undesirable powder migration.

With reference to FIG. 8A, in certain alternative embodiments, a gas purification system (regeneration system) may be interposed in several locations (such as along sixth conveyance loop 821, seventh conveyance loop 824, or as a standalone loop (e.g. between first volume 803 and second volume 804). A gas purification system may serve to remove or lower the concentration of undesired components of a gaseous atmosphere from a gas stream, for example removing oxygen, water vapor, or other species from a stream of recirculated gas. Such a gas purification system may function by passing recirculated gas through a column containing an active media which is disposed to react to the components of the gas stream desired to be removed. As will be understood by one skilled in the art, other types of gas purification systems may also be used, such as dehumidifying systems, cryogenic systems, or any suitable system which may reduce the concentration or the presence of one or more components which may be deleterious to the printing environment. Certain alternative embodiments may further or instead include an overpressure relief system consisting of pressure relief valves to prevent over-pressurization that may otherwise damage the system. For example, in the case of an unexpected or undesired over-pressurization of any of the volumes or conveyance loops described, a pressure relief valve may be disposed to automatically open to allow gas to exit the system before the pressure can exceed a burst pressure of the volumes or loops.

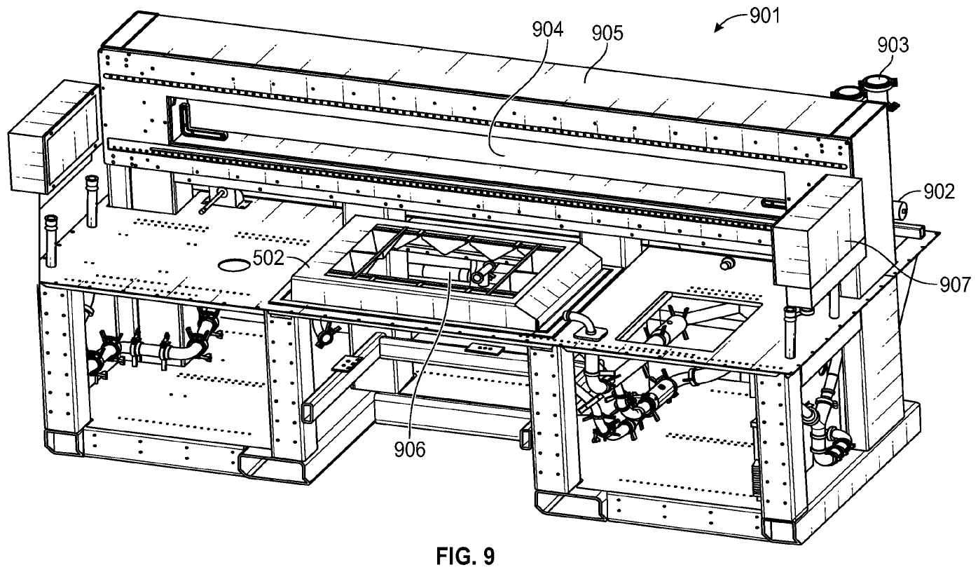

FIG. 9 depicts a partial internal view of an embodiment binder jetting printer 901. A process gas inflow line 902 provides an inflow of process gas to a first volume. A process gas outflow line 903 provides an outflow of used process gas from the binder jetting printer 901. Used process gas may comprise process gas which is not desirable for recycling or reuse in the printer, for example due to having a higher than desired amount of an undesirable component such as oxygen or water vapor. An aperture 904 provides gaseous communication between a first volume and a second volume through a partition 905. An aperture 906 provides gaseous communication between a second volume and a third volume. Diffusers 907 provides additional process gas inflow to the second volume.

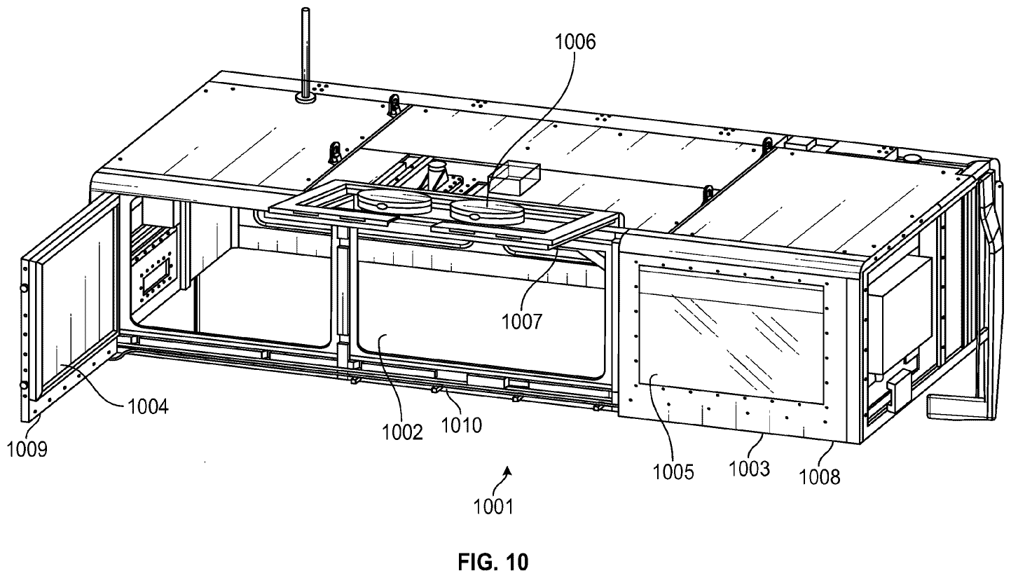

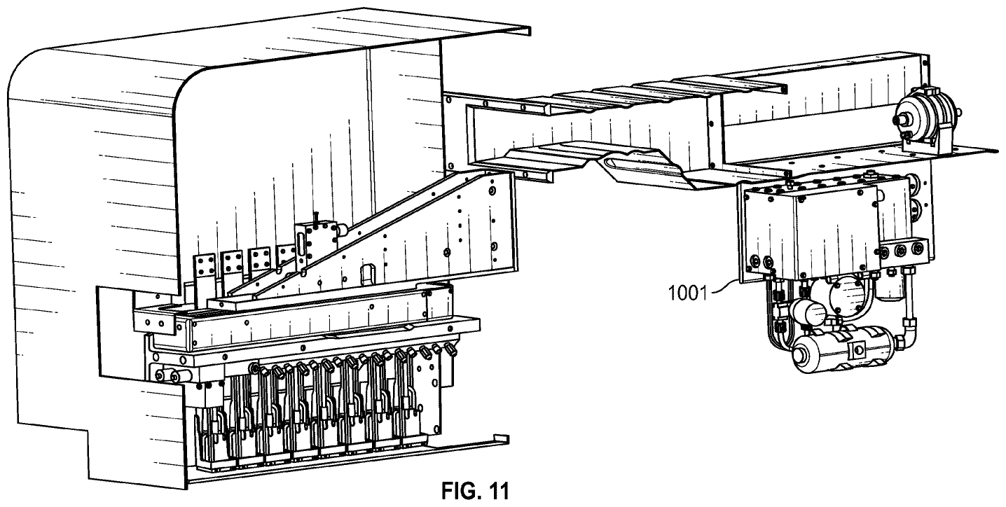

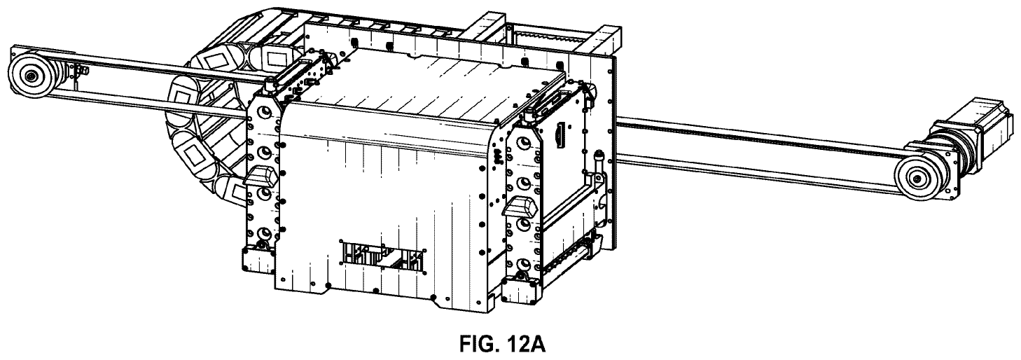

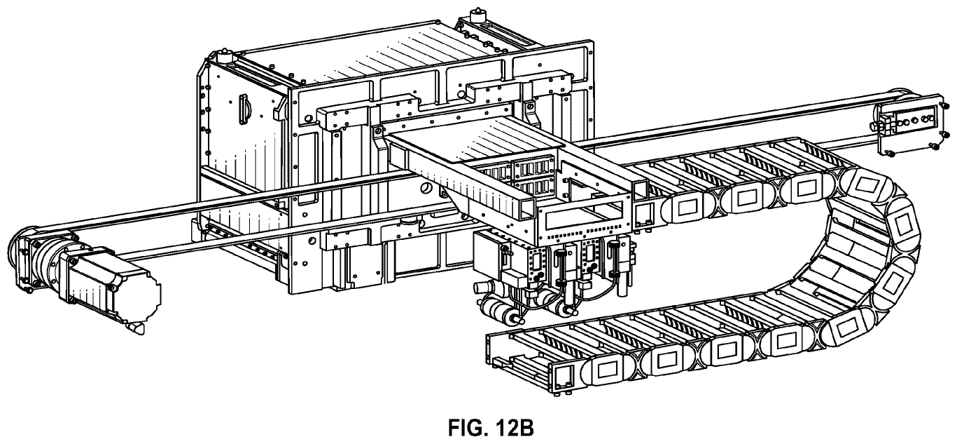

FIG. 10 provides a perspective view of a multi-pane door assembly 1001 configured to seal a sealable printing chamber 1002 via a plurality of multi-pane doors 1003. A set of inner panes 1004 may be constructed from an electrostatically dispersive transparent material, for example glass with a coating of FTO (fluorine-doped tin oxide) and a set of outer panes 1005 may be constructed from a second material, for example polycarbonate. The inner panes 1004 and outer panes 1005 are spaced apart a distance sufficient to store a set of gloves connected to a set of glove ports 1006 in the outer pane. The multi-pane doors include a center door 1007 and a first side door 1008 and a second side door 1009, wherein the center door 1007 is configured to only be closeable when the first side door 1008 and the second side door 1009 are closed, and wherein the first side door 1008 and second side door 1009 are configured to only be openable when the center door 1007 is open. A lock out device 1010 is configured to lock the center door 1007 during the binder jetting additive manufacturing process. The multi-pane door assembly may be supported by a gas spring system configured to support the mass of the door during opening and while in an open position. The multi-pane door may be desirable to allow for some components of the door, including sensor elements, switches, latches, wires, and the like, to be hidden in a cavity between an inner frame and an outer frame, thus removing the need for components to be inside a printing volume where they may be exposed to powder during a printing process.

What is claimed:

1. A system for binder jet additive manufacturing from build material powder, comprising:
a first volume at least partly within a binder jet printer containing gas at a first pressure;
a second volume within the binder jet printer that encloses a plurality of process modules configured to deposit and bind build material powder during an additive manufacturing process, the second volume containing gas at a second pressure;
a boundary between the first volume and the second volume, the boundary including a partition providing separation between the first volume and the second volume, the partition controlling gaseous communication between the first volume and second volume; and
a gas management system configured to maintain a conditioned environment within the second volume during the process of additive manufacturing from a build material powder by selectively providing to the second volume an inflow of process gas, at least some amount of the flow of process gas originating from the first volume and flowing across the boundary; and
wherein the first pressure of the gas in the first volume is greater than the second pressure of the gas in the second volume.

2. The gas management system of claim 1 wherein the inflow of process gas includes an amount of gas recycled from the second volume.

3. The gas management system of claim 1 wherein the inflow of process gas is provided by an external gas source.

4. The gas management system of claim 1 wherein the first volume and the second volume are at least partially isolated from one another by bellows at the boundary.

5. The gas management system of claim 4 wherein the bellows are constructed from an electrostatic-dispersive material.

6. The gas management system of claim 1 wherein the plurality of process modules includes a printhead mounted to a carriage and having a compressible seal therebetween.

7. The gas management system of claim 1, further comprising:
a z-lift enclosure accessible to a printing chamber of the binder jet printer via an aperture and configured to deliver a work surface of a build box to the printing chamber.

8. The gas management system of claim 7 wherein the gas management system is configured to maintain a conditioned environment in the z-lift enclosure independently of the second volume.

9. The gas management system of claim 1 wherein a gas pressure in the second volume is higher than a pressure of an ambient environment surrounding the second volume.

10. The gas management system of claim 1 wherein gas pressure in the second volume is lower than a pressure of an ambient environment the second volume.

11. The gas management system of claim 1 wherein the second volume is a sealable printing chamber sealed via a plurality of multi-pane doors.

12. The gas management system of claim 11 wherein the multi-pane doors include a set of inner panes constructed from an electrostatically dispersive transparent material and a set of outer panes constructed from polycarbonate.

13. The gas management system of claim 12 wherein the inner pane and outer pane are spaced apart a distance sufficient to store a set of gloves connected to a set of glove ports in the outer pane.

14. The gas management system of claim 11, further comprising:
wherein the plurality of multi-pane doors include a center door and a first side door and a second side door, wherein the center door is configured to only be closeable when the first side door and the second side door are closed, and wherein the first side door and second side door are configured to only be openable when the center door is open; and
a lock out device configured to lock the center door during the binder jetting additive manufacturing process.

15. The gas management system of claim 8, further comprising a pressure equalization tube between the second volume and the z-lift enclosure.
